(19) United States
(12) Patent Application Publication
(10) Pub. No.: US 2018/0299264 A1
(43) Pub. Date: Oct. 18, 2018

(54) HELIOSTAT CHARACTERIZATION USING STARLIGHT

(71) Applicant: SOLARRESERVE TECHNOLOGY, LLC, Santa Monica, CA (US)

(72) Inventor: Braden E. Hines, Pasadena, CA (US)

(73) Assignee: SOLARRESERVE TECHNOLOGY, LLC, Santa Monica, CA (US)

(21) Appl. No.: 15/737,890

(22) PCT Filed: Jun. 17, 2016
(86) PCT No.: PCT/US2016/038033

§ 371 Date: Dec. 19, 2017

Related U.S. Application Data
(60) Provisional application No. 62/182,196, filed on Jun. 19, 2015.

(51) Int. Cl. G01B 11/26; F24S 23/70

(52) U.S. Cl. CPC G01B 11/26; F24S 23/70

(57) ABSTRACT

The present invention offers an improvement to existing canting, slope error, and/or pointing measurement approaches, by using one or more cameras to observe the reflections of points of light in the firmament, such as the reflections of stars and/or planets as visible within the night sky in the heliostat facets. An illustrative heliostat measurement system comprises a plurality of heliostats, and at least one camera that observes at least one heliostat. The heliostats reflect an image of the firmament that can be observed by the at least one camera. The system further comprises (i) at least one captured image of the firmament reflected from at least one of the heliostats; and (ii) a computer comprising programming that determines a heliostat imperfection from the captured image, wherein the heliostat imperfection is selected from at least one of a slope error, a canting error, and a pointing error.

### PRIORITY

This application claims the benefit of U.S. Provisional Patent Application Ser. No. 62/182,196, filed on Jun. 19, 2015, the entire disclosure of which is incorporated herein by reference for all purposes.

### FIELD OF THE INVENTION

The present invention relates to the optical alignment of heliostats used to reflect sunlight to a target in a solar power plant in the field of concentrating solar power (CSP). More specifically, the invention relates to the relative alignment of individual facets of a multi-facet heliostat or a single-facet heliostat, measurement of the shape of individual facets, and an overall pointing of one or more heliostats.

### BACKGROUND OF THE INVENTION

The use of heliostats in the field of concentrating solar power (CSP) is well established in the prior art. A typical CSP system includes at least one centralized tower and a plurality of heliostats corresponding to each centralized tower. The tower is centralized in the sense that the tower serves as the focal point onto which a corresponding plurality of heliostats collectively redirect and concentrate sunlight onto a target (also referred to as a focus or a receiver) associated with the tower. The concentration of sunlight at the tower receiver is therefore directly related to the number of heliostats or other concentrators associated with the tower up to certain fundamental limits. This approach can concentrate solar energy to very high levels, e.g., on the order of 1000× or more if desired. In practical application, many systems concentrate sunlight in a range from 50× to 5000×. The high concentration of solar energy can then be converted by the tower receiver into other useful forms of energy. One mode of practice converts the concentrated solar energy into heat to be used either directly or indirectly, such as by generating steam, to power electrical generators, industrial equipment, or the like. In other modes of practice, concentrated solar energy can be converted directly into electricity through the use of any number of photovoltaic devices, also referred to as solar cells.

The goal of the heliostat is to reflect sunlight to a target. Any imperfections in the heliostat or its operation can cause sunlight to miss or unevenly illuminate the target, resulting in lost energy and lost revenue.

A heliostat generally comprises one or more mirrors, often referred to as facets, which are attached to an articulating structure. At the highest level, heliostat imperfections can be divided into three categories: Imperfection in the facets themselves, imperfect alignment of the facets to each other, and imperfect pointing of the entire heliostat. The prior art has provided numerous approaches to solving each of these three problems.

The first of these, imperfections in the facets themselves, is called “slope error.” Specifically, slope error is the deviation of the actual mirror shape for a facet vs. its ideal or predetermined mirror shape. Each facet is generally designed so that its mirror surface will have some desirable shape, such as flat, or possibly curved, in order to reflect the light in a preferred way. If the facet does not match this desired shape, light will be reflected in a less preferable way, possibly leading to lost sunlight.

Numerous techniques exist for measuring slope error using laboratory equipment. Techniques include surface profilometers, as well as surface mappers such as the Sandia National Laboratories' SOFAST system. These systems tend to be fixed instruments—in order to perform a test, a facet is brought to the laboratory, tested, and then returned for integration with a heliostat.

Unfortunately, the slope error of a facet can change in many ways between the laboratory and emplacement in the field, depending on temperature, or humidity, or the nature of the facet's attachment to the heliostat, or the angle at which the heliostat is pointed (inducing different gravity and structural loads that can deform the facet). It would thus be desirable to have a way to measure slope error for a facet in situ, in order to characterize its actual performance as installed, and also to help diagnose any sources of facet distortion that are occurring in situ.

The second source of imperfection is imperfect alignment of the facets. When a heliostat comprises more than one facet, it is frequently desirable to align the facets relative to each other, so as to obtain some desired property of the reflected sunlight, such as a minimum size of the reflected sunlight spot on the target. Sometimes this process is thought of as focusing the heliostat, but the heliostat may be adjusted according to any useful strategy. Multi-faceted heliostats generally provide a means for adjusting and maintaining proper alignment, and this process of adjusting individual facets is called canting.

The canting problem falls into two parts: 1) the selection of a desired canting strategy, and 2) the adjustment of the facets to implement the desired canting strategy. The present invention is concerned with the second of these. There are any number of desirable canting strategies that may be used. For example, one typical strategy is to adjust the facets to approximate the shape of a portion of a sphere. The present invention may be used with any desired canting strategy.

Adjustment of the facets often comprises a step of measuring the canting of the one or more facets to see to what degree the canting differs from to the desired canting. Once this difference is measured and any differences determined, corrective adjustments can be made.

Many techniques for performing this measurement have been explored in the literature. A useful survey of canting problems and of techniques that have been proposed to address canting is a 2010 paper by Yellowhair and Ho, entitled “Heliostat Canting and Focusing Methods: An Overview and Comparison”, from the ASME 2010 4^{th} International Conference on Energy Sustainability. Prior art measurement techniques include mechanical techniques such as inclinometers, optical techniques that involve analyzing the reflections of laser beams, and optical techniques that involve analyzing the reflections of known objects or specially constructed targets.

In general, one thing that these prior art canting measurement techniques have in common is the requirement for a precision reference. Any errors in the reference can lead to errors in the estimation of the actual canting of a given facet. For example, the use of inclinometers requires a precision inclinometer whose zero point is accurate as the inclinometer is moved from facet to facet. Techniques involving laser beams require highly accurate pointing of the laser beams—any errors in knowledge of laser beam pointing propagate into the measured canting angles. Techniques involving targets are dependent on having an accurate target and on pointing the heliostat accurately at the target during measurement.

Further, prior art techniques may suffer from undersampling. That is, if an individual mirror facet matches its ideal shape (it may be flat, although usually the facets are desirably slightly concave), then the measurement of a single point on the surface of the mirror is an accurate representation of the canting of the entire facet. However, many practical heliostat mirrors have slope error, as discussed above, and thus do not closely match their ideal shape. In fact, the mirror surface may have numerous undulations that are larger in size than the accuracy with which it is desired to estimate the canting of the heliostat. Slope error may limit the accuracy of canting estimates that rely on a small number of points. In order to get an accurate estimate of the canting, it is desirable to measure many points on the mirror surface, perhaps as many as one hundred, or even one thousand or more points, in order to determine an accurate average angle for the mirror surface. A canting measurement approach that can measure hundreds or thousands of points per facet would be desirable.

Specialized equipment exists (such as the Sandia SOFAST measurement device) for measuring the surface angles of an individual heliostat facet at thousands of points. (SOFAST uses the approach of observing the reflection of a precision target.) However, SOFAST is limited in the size of the mirror assembly that it can observe, and it can only observe in certain orientations.

Some prior art techniques require that the heliostat be placed in a particular location relative to the canting measurement equipment. This is acceptable during manufacturing, but does not give any information about how the heliostat is canted once it is deployed in the field. Some prior art systems are capable of in situ measurement. They generally require special targets, screens, or the like, which typically are brought to the location and precisely set up with respect to the heliostats. Another approach, HFACET, uses neighboring heliostats as the targets. This approach is subject to limitations due to physical articulation limits of the heliostats, and due to the blocking of reflections by other heliostats.

A limitation of most canting measurement techniques is that they only measure canting. For power plant performance, slope error is just as important as canting error, and it is desirable to be able to determine slope error as well.

A further limitation of existing systems is that they typically only measure canting at one particular heliostat orientation. The geometry of the system requires that the heliostat be placed at a specific angle relative to the measuring target or equipment. One skilled in the art will appreciate that one error source that is of some concern is structural deflection—as the heliostat articulates to different angles, the structure that holds the facets can undergo deflection and deformation. This causes the effective canting to change as a function of angle, but this is not observable by a typical prior art system. It would be desirable to have a system that could measure structural deflection by observing how canting varies as the heliostat is articulated to different angles.

The third source of imperfection is overall heliostat pointing. The typical prior art approach is to program the heliostat to “point blind”. Like a pilot flying on instruments, the heliostat does not “see” the sun or the target. The heliostat control system is simply programmed with information about the heliostat's location, the location of the tower, the latitude and longitude of the power plant, and the time. From these quantities, the sun position can be computed, and then the desired orientation of the heliostat mirror can be computed. The heliostat is then commanded to point to that desired orientation.

Since there is no feedback as to how well this process is working, it is error-prone. Any imperfections in the mechanical structure of the heliostat, cyclic errors in its geartrain, non-verticality of the pedestal on which it is mounted, imperfect knowledge of its location, or the like, are sources of error for this blind pointing calculation. Typically, if these errors are left unmeasured and uncorrected, significant loss of reflected sunlight may occur.

Fortunately, many of these errors are very repeatable—since they are related to the detailed geometry of the heliostat, the nature of the errors remains the same as long as the heliostat geometry remains the same. Therefore, in order to help alleviate mispointing due to these errors, prior art systems tend to use various techniques to measure the quantities that lead to these errors, allowing them to be predicted and corrected for.

The usual prior art approach for measuring the errors is to command the heliostat to reflect sunlight onto a test target, not unlike a giant screen at a drive-in movie theater. The shape of the resulting sunlight spot, including the amount by which the reflected sunlight tends to miss the center of the test target, is recorded. After many measurements are made, at different times of day and different times of year, it is possible to accurately solve for the heliostat geometry.

A limitation to this approach is that an accurate solution requires making measurements at a broad distribution of heliostat angles, resulting in the requirement to observe at different times of day and different times of year. If, for example, only a single day of measurements is used, the heliostat will tend to point accurately at times of year near that day, but may point poorly at other times of year.

Thus these sorts of prior-art systems have the limitation that, in general, it takes 6-9 months to fully sample the operating angles of the heliostat and produce an accurate solution. This creates a “long tail” on the schedule for power plant commissioning, wherein commissioning activities must continue for many months after the plant is constructed and otherwise operational.

It would be desirable to have a system which can make measurements over a broad distribution of angles in a short time, thus expediting commissioning.

Some prior art systems can view and measure multiple heliostats at once, while others are limited to measuring a single heliostat. Since a power plant may include tens of thousands or even hundreds of thousands of heliostats, for in situ measurements, a system that can measure many heliostats at once tends to be preferable, so that the entire field of heliostats can be characterized in a reasonable amount of time (a few days as opposed to many months).

More recently, eSolar, Inc. of Burbank Calif., has partially solved the multiple-heliostat problem by providing multiple test targets. Instead of reflecting the sun onto a target, they reflect the sun into a camera, and they provide multiple cameras on multiple poles, sprinkled around the field. Further, the geometric diversity of the camera locations allows the heliostats to be articulated to a broad range of angles in a shorter time.

In general, however, prior art systems for measuring and controlling canting, slope error, and pointing error are distinct and separate systems. It would be desirable to have a single system which could make all three types of measurements, in situ.

These prior art solutions are useful, are in use today, and provide effective tools for heliostat and mirror alignment. Nonetheless, it is desirable to have measurement approaches that could:

1) make measurements without requiring precision equipment,

2) make measurements without requiring a large number of targets or poles,

3) make measurements of heliostats in situ,

4) make measurements of heliostats in a variety of orientations,

5) measure slope error in addition to canting error,

6) measure pointing error in addition to slope error and canting error,

7) measure hundreds or thousands of points per facet,

8) characterize structural deflection,

9) measure multiple heliostats simultaneously, and

10) require no equipment out in the heliostat field.

### SUMMARY OF THE INVENTION

The present invention offers an improvement to existing canting, slope error, and/or pointing measurement approaches, by using one or more cameras to observe the reflections of points of light in the firmament, such as the reflections of stars and/or planets as visible within the night sky in the heliostat facets. Such firmament reflections may be light from any suitable celestial body, including but not limited to stars and planets. Planets include Mars, Venus, Jupiter, and Saturn,

The positions of stars within the night sky for any given location and time of the year are extremely well known. The Hipparcos mission, for example, measured 100,000 stars with an accuracy of about 0.001 arcseconds, or about 4.8 nanoradians. Moreover, the view of the night sky in its entirety at any given moment, namely the firmament, is known to this level of detail for any location and time of the year. The required accuracy for measuring the canting angles of a heliostat is perhaps 0.1 milliradians. So the star positions are known about 20,000 times more accurately than is required in order to act as good references for canting, slope error, and position measurement.

In practice, when stars and/or planets are viewed from any position on earth (as opposed to in space), there is a little additional uncertainty introduced because of atmospheric refraction, which depends on the temperature and humidity of the air. But the effect is small unless the stars and/or planets are near the horizon, and further, since canting and slope error measurements are really the measurement of relative differences in angle between and within the facets of a heliostat, any error due to refraction largely drops out since it is approximately the same for any given star or planet over a short period of time. For overall heliostat pointing, refraction is an effect that is largely common to both daytime and nighttime observations, so its effect again tends to drop out.

Thus stars and/or planets provide excellent precision reference points that can be utilized for slope error evaluation, canting measurement and heliostat alignment. By using precisely known star and/or planet positions as reference points, the need for precision equipment is eliminated. In essence, the use of stars and/or planets as reference points leverages billions of dollars and generations of investment in high-precision equipment by the astronomy community, for free.

Further, there are stars throughout the entire sky, so we can make measurements for any orientation of the heliostat that reflects starlight to the measurement camera.

CSP power tower plants generally have a central tower. A convenient place to put a measurement camera, or other imaging device, for use in accordance with measuring aspects of the present invention is therefore near the top of the tower. In one embodiment, one or more cameras are placed near the top of the tower. From there, a camera is capable of seeing a plurality of heliostats and thus measuring the canting, slope error, and/or pointing of many heliostats simultaneously. The preference is to provide and locate one or more cameras with sufficient resolution to accurately be able to view the facets from all heliostats of a field. Depending on the number of points of measurement desired for any particular facet, as discussed more below, a useful camera resolution can be determined. The number of image pixels of resolution should be sufficient in order to pick up the number of points needed within an imaging field of vision. Further the lens or optical system used with the camera desirably will have sufficient resolving power to be able to discern the desired points as independent points. For uses of the present invention, it has been determined that a commercially available digital camera having around twelve megapixels of resolution is more than sufficient for obtaining necessary points from multiple facets and of multiple heliostats at the same time. No matter how many heliostats are imaged, the question of sufficient resolution comes down to the ability to see enough points on any or all measured facets, and to the ability to resolve them optically, which number of points is determined by any means suitable to the heliostat tester. Imaging devices can be placed in many locations, based primarily on the ability to view a decided field of view of certain heliostats and their mirror facets.

In one aspect, the present invention relates to a method of measuring one or more heliostat imperfections selected from at least one of a slope error, a canting error, and a pointing error, comprising the steps of:
a) providing a plurality of heliostats and at least one camera that observes at least one heliostat, wherein the heliostats reflect an image of the firmament that can be observed by the at least one camera;
b) reflecting an image of the firmament from at least one of the heliostats:
c) using at least one camera to capture the reflected image of the firmament;
d) using the image comprising the reflected image of the firmament to measure the heliostat imperfection.

In another aspect, the present invention relates to a heliostat measurement system, comprising:
a) a plurality of heliostats, and
b) at least one camera that observes at least one heliostat, and
   wherein the heliostats reflect an image of the firmament that can be observed by the at least one camera; and wherein the system further comprises (i) at least one captured image of the firmament reflected from at least one of the heliostats; and (ii) a computer comprising programming that determines a heliostat imperfection from the captured image, wherein the heliostat imperfection is selected from at least one of a slope error, a canting error, and a pointing error.

An exemplary heliostat measurement system is shown in FIG. 1. System 1 comprises one or more heliostats 3, which each may comprise one or more facets 5. One particular facet is labeled as facet 23.

During energy production, the heliostat reflects sunlight to the target 7 atop tower 17. However, when making measurements according to the present invention, it reflects starlight or other firmament light generally towards one or more cameras 9. For purposes of illustration, reflected starlight from star 11 is shown.

Star 11 emits light that strikes the heliostat. The incoming rays from the star are essentially all parallel to one another. One of these rays 13 is shown striking facet 23 at point 19. This results in a reflected ray 15. Depending on the orientation of the heliostat and location of the star, the reflected ray 15 may be reflected in the general direction of camera 9.

Line 21 is the line-of-sight vector from reflection point 19 to camera 9. The laws of reflection dictate whether the ray 15 will be reflected into the camera 9. If the normal to the surface of the mirror 23 at point 19 bisects the vectors represented by starlight ray vector 13 and line-of-sight vector 21, then ray 15 will coincide with vector 21 and will enter the camera and strike the center of its detector, creating an image of the star in the center of the camera image.

Thus, if the star is detected in the center of the camera image, we can conclude that the mirror normal at point 19 is, in fact, the bisector of vectors 13 and 21. We thus know the normal to the mirror surface at that one point. Knowledge of this mirror normal comprises a measurement of the slope of the mirror at that point on the mirror.

The vector geometry is shown in more detail in FIG. 2, which is a side view of a facet 31 comprising points 33 and 35. In this figure, another star 25 produces parallel rays 27 and 29 which strike facet 31 at points 33 and 35 respectively. The mirror normal vector at point 33 is shown by vector 37. The reflected ray 39 satisfies the law of reflection, which requires that the mirror normal vector 37 is the bisector of incident ray 27 and reflected ray 39.

At point 35, the surface of the facet 31 is tilted with respect to the rest of the facet 31. This is an illustration of slope error. The result of slope error is that reflected ray 41 is not parallel to reflected ray 39.

A canting error, which is a tilting of the entire facet 31, would result in deflection of both rays 39 and 41.

In understanding the measurement of canting and slope error via starlight, it is useful to consider the same kind of optical system, but instead trace rays backwards from a camera or other imaging device. Each pixel in a captured image corresponds to a ray which has approached the camera from a slightly different angle. This is shown in FIGS. 3 and 4. In FIG. 3, a camera 43 views a heliostat comprising a facet 45. Camera 43 has line of sight 47.

FIG. 4 shows the image 69 produced by camera 43 of the scene in FIG. 3. Line of sight 47 of camera 43 corresponds to the center 71 of the camera image 69.

Referring back to FIG. 3, other vectors 49 and 51 correspond to pixels 73 and 75 of the image of FIG. 4, respectively. Thus, camera pixels 71, 73, and 75 will “see” reflected rays 53, 55, and 57 respectively.

In the scene of FIG. 3, star 59 appears in the firmament at the source of ray 53. Accordingly, an image of star 59 appears at pixel 71 in the captured camera image. Likewise, star 63 appears in the firmament at the source of ray 57, so its image appears at pixel 73. However, at point 61 in the firmament, there is no star, so ray 55 carries no light, and no image is formed at point 73.

Thus we see that the camera can image a map of the firmament, but with the map tilted by facet 45 and distorted by any slope error that facet 45 may have. Conversely, by measuring the distortion and tilt of the star map, we can infer the canting and slope error of facet 45.

The same is true for measuring heliostat pointing. To measure heliostat pointing, one can pick some point on the heliostat as the reference point for pointing measurement. Often the center of the heliostat is picked. There is some pixel of the camera that images the center of the heliostat, and the center of the heliostat maps some point in the firmament onto that pixel. If there is a star or planet at that point in the firmament, then the star image is seen on that pixel.

Conversely, the pointing of the heliostat can be adjusted until a star or planet image does, in fact, appear on that pixel. Once that adjustment has been made, the position of that star or planet can be recorded along with the pointing angles of the heliostat, and those items comprise a pointing measurement.

Thus pointing, slope error, and canting measurements can be determined by observing the mapping of the firmament into the captured camera image.

However, since the nighttime firmament is mostly comprised of black emptiness, most pixels of the camera see nothing and collect no information, so any given image reveals only a small amount of information about slope error and canting. In fact, some images may have no bright stars or planets at all in them.

One way to deal with this would be to move the camera around. As the camera moves, different parts of the firmament would be reflected onto different camera pixels, allowing slope error and canting maps to be slowly constructed.

A better approach, however, is to move the firmament relative to the camera(s). There are two ways to move the firmament. One is simply to wait. Due to earth rotation, the firmament predictably moves naturally. Over a long enough period of time, stars or planets will sweep across most regions of the heliostat's facets, and a map of the facet can be constructed. The other way to move the firmament is to make it appear to move, by controllably articulating the heliostat to a predetermined orientation, or along a predetermined path. As the heliostat is articulated, rays from the stars or planets in the firmament sweep across the mirror and cause transient illumination of the various camera pixels. By recording the illumination pattern and correlating with known star positions and with heliostat pointing, a detailed map of the canting and slope error of each facet can be constructed.

Since the entire firmament is filled with stars, observations can be made at any desired heliostat angle. Thus it is possible to quickly take the broad distribution of points needed to accurately solve for the heliostat geometry. This phase of commissioning may thus be done in a single night, for example, if desired, rather than requiring half a year or more.

Further, since measurements can be made in any orientation, it is also possible to discern the effects of gravity and other angle-dependent errors on the heliostat.

Now, in FIG. 3, the camera 43 is shown viewing a single facet 45. Clearly, a typical camera has many megapixels, and a suitable lens can be chosen so that the camera can simultaneously observe many facets, and/or even many heliostats. Many embodiments of the invention include lenses that image a plurality of facets and heliostats, even as many as a hundred, or even as many as a thousand, or even more heliostats. Detectors with large numbers of pixels are contemplated, as are lenses or other imaging optics with varying apertures and varying degrees of zoom, as are necessary to view different parts of the field at a desired resolution. Using detectors with large numbers of pixels tends to allow the use of fewer cameras, helping to reduce system cost. The use of large-aperture lenses with high zoom factors helps to allow the observation of distant heliostats, while smaller lenses with less zoom may be used for nearer heliostats.

The invention thus addresses the desire for a measurement system that can

1) make measurements without requiring precision equipment,

2) make measurements without requiring a large number of targets or poles,

3) make measurements of heliostats in situ,

4) make measurements of heliostats in a variety of orientations,

5) measure slope error in addition to canting error,

6) measure pointing error in addition to slope error and canting error,

7) measure hundreds or thousands of points per facet,

8) characterize structural deflection,

9) measure multiple heliostats simultaneously, and

10) require no equipment out in the heliostat field.

The present invention can be used with virtually any heliostat system for concentrating solar power.

### BRIEF DESCRIPTION OF THE DRAWINGS

FIG. 1 illustrates a starlight observation capability coupled to a concentrating solar power system.

FIG. 2 illustrates starlight rays being reflected from a heliostat facet.

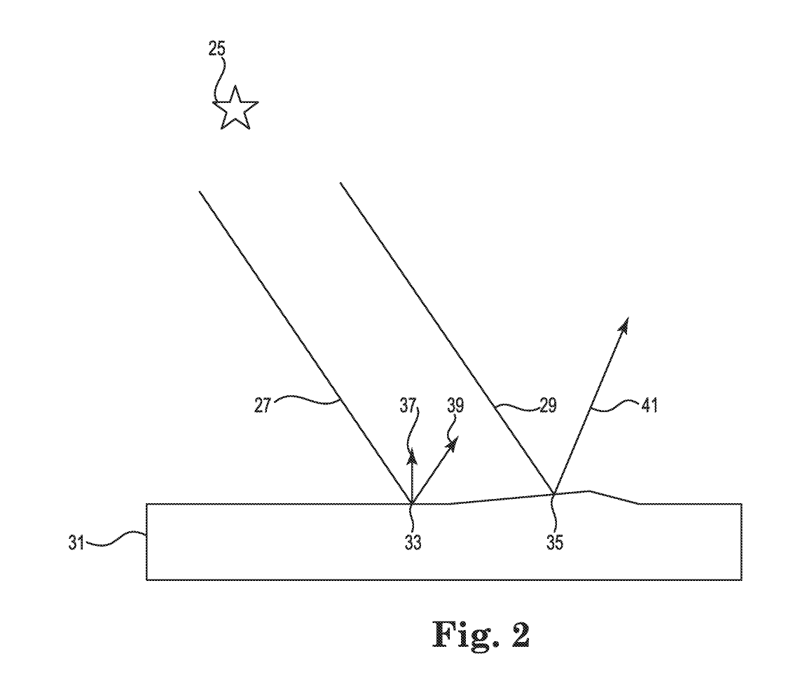

FIG. 3 illustrates how a camera views a reflection of the firmament from a heliostat facet.

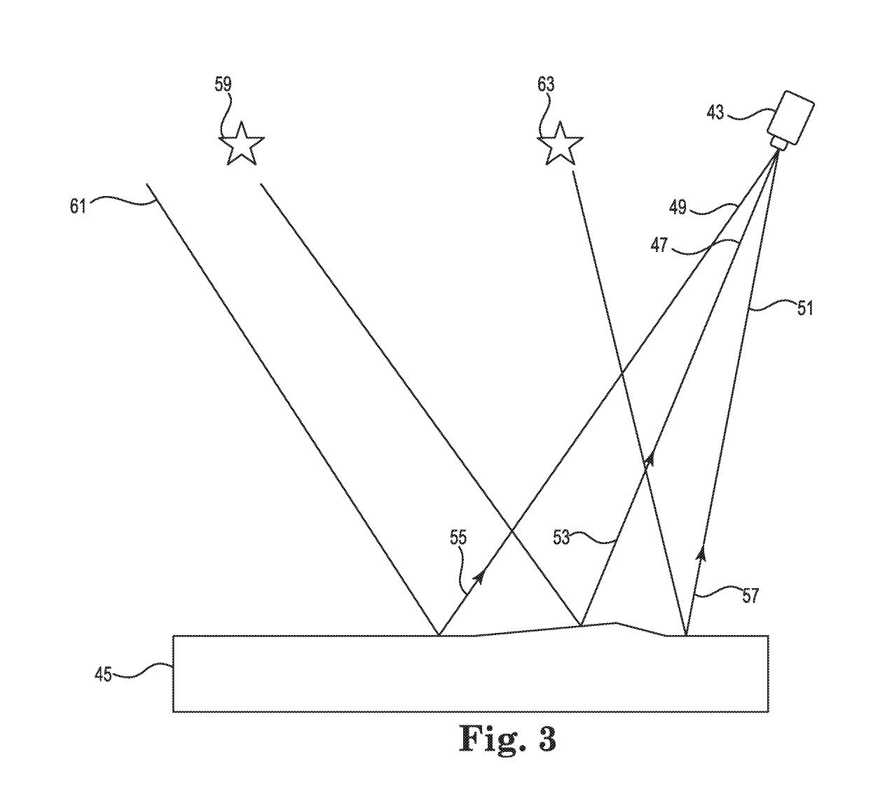

FIG. 4 is an image of the firmament formed by a camera viewing the heliostat facet of FIG. 3.

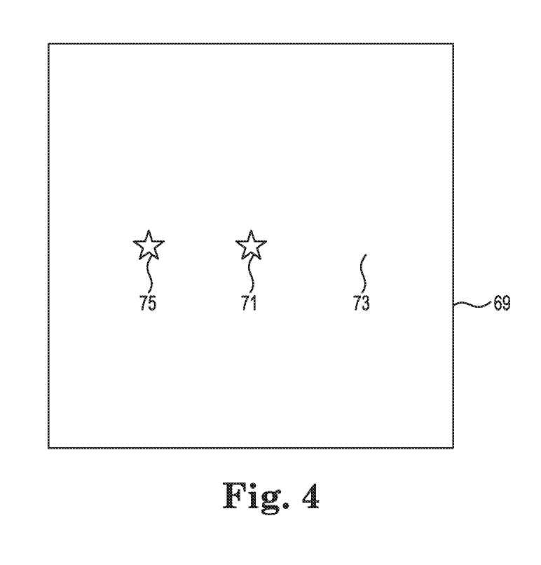

FIG. 5 shows a star transiting across a stationary heliostat due to earth rotation.

FIG. 6 shows how an improperly canted facet results in displacement of a segment of a star transit.

FIG. 7 shows how slope error results in the distortion of the star transit.

FIG. 8 shows how a plurality of transits may be used to build a more complete map of the heliostat mirror surface.

FIG. 9 illustrates transits that may result from appropriately commanded heliostat movements.

FIG. 10 shows how slope and canting errors are measured via a method where stars are controlled to appear at specific points on the heliostat.

FIG. 11 illustrates how pointing error measurements can be made by pointing at multiple stars.

### DESCRIPTION OF THE INVENTION

Embodiments described herein are exemplary and do not represent all possible embodiments of the principles taught by the present invention. In particular, embodiments of the present invention have direct application in the field of concentrating solar power, particularly concentrating solar power including the use of heliostats to redirect sunlight onto a fixed focus in which concentrated sunlight may be converted into other forms of energy such as heat or electrical energy. Nevertheless, the apparatus and methods described herein can be applied and adapted by those skilled in the art for use in alternative applications in which the optical characteristics of a mirror must be measured from a distance.

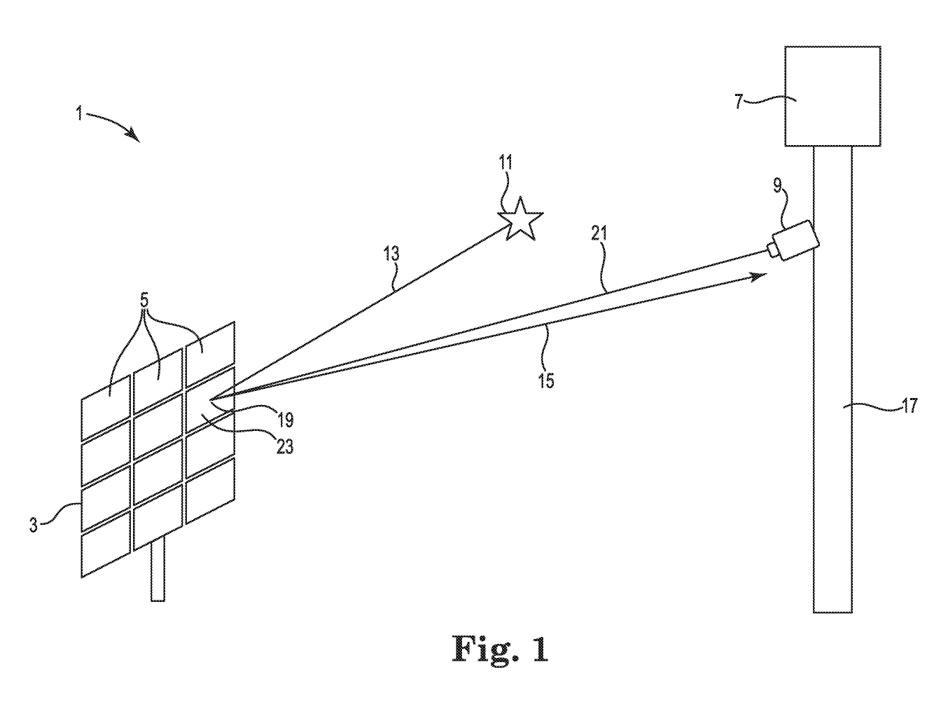

As shown, in FIG. 1, an exemplary CSP system 1 can include an array of heliostats 3 that redirect and concentrate sunlight onto a focus area 7 of a tower 17. Each heliostat 3 may include one or more mirror facets 5.

An embodiment of the invention includes a digital imaging device, preferably a camera 9, which can observe the reflections of stars or planets in one or more of the individual facet mirrors 5 of one or more heliostats 3. The camera 9 may be mounted on the power plant's central tower 17, but it may also be mounted in any convenient place which provides a desirable vantage point for viewing one or more heliostats 3. Multiple cameras at multiple locations may be used.

Canting and slope error, as discussed above, may be measured by observing the reflections of stars at a plurality of points in each heliostat facet 5. Heliostat pointing, also discussed above, can be measured by observing the reflection of one or more stars or planets a one or more points in the heliostat mirrors.

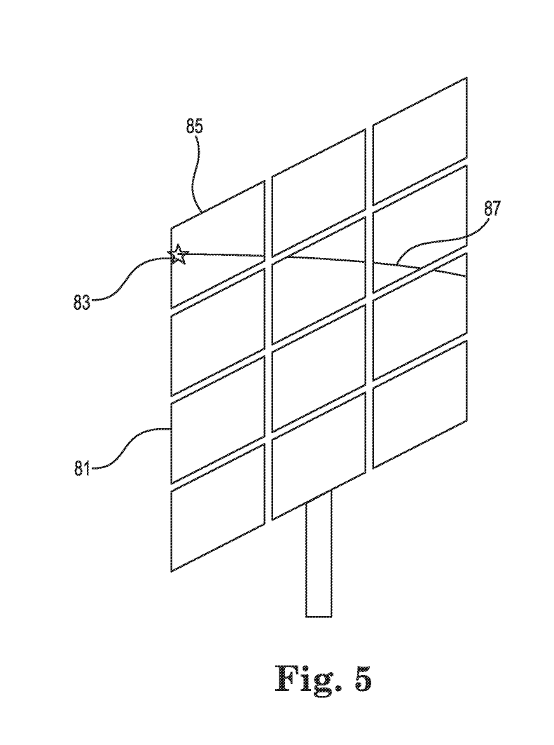

In one embodiment, a plurality of points may be obtained while keeping the heliostat stationary. As the earth rotates, stars or planets are observed to transit the heliostat. This is shown in FIG. 5. FIG. 5 shows heliostat 81, which is oriented so as to reflect a portion of the night sky into a camera such as camera 9 of FIG. 1. FIG. 5 shows the scene as would be observed by the camera. Note that the heliostat is intentionally shown at an angle, to underscore the fact that the heliostat need not be facing the camera, and in fact, may be in any orientation that reflects the night sky into the camera.

As the earth rotates, the reflection 83 of a star may appear in one of the facets 85, as shown. As the earth continues to rotate, the image of the star will tend to transit across the face of the heliostat mirror, tracing out an arcing path 87. The figure shows the transit path for a heliostat in which all the facets are flat, and all parallel to each other. For heliostats with other facet shapes, such as being slightly concave, the transit path can also be determined using known mathematical formulas of geometry. In any case, it is one aspect of the present invention to determine an expected path based upon the occurrence of a star reflection at a given location. In certain methods of the present invention, it may be desirable to compare a determined path to the actual transit for making measurements in accordance with the present invention.

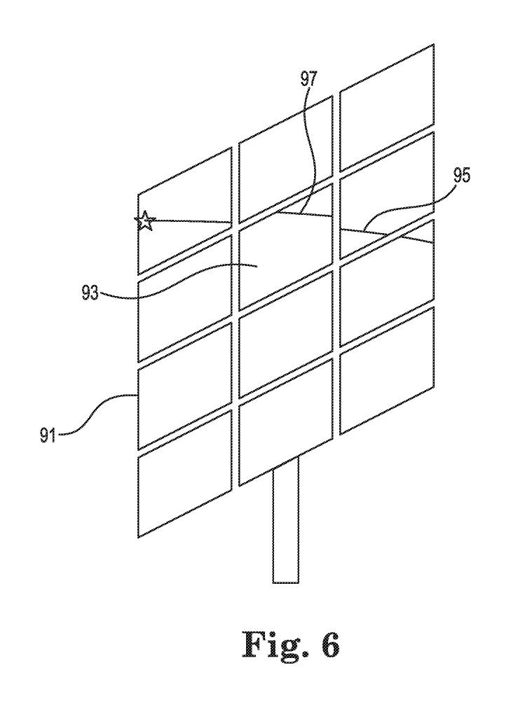

If a flat-faceted, parallel-canted heliostat has a facet with a canting error, the transit will be offset in the corresponding facet, as shown in FIG. 6. In FIG. 6, heliostat 91 has facet 93 that is canted upward from its correct canting, and a segment 97 of transit 95 is displaced vertically as a result. Similar offsets would be seen with other faceted shapes as well, although the path may be different.

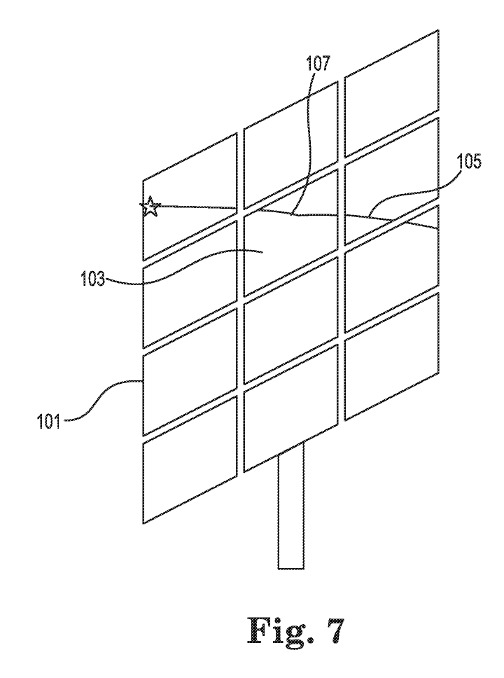

Similarly, FIG. 7 shows a heliostat 101 in which a facet 103 has a slope error. In this case, a segment 107 of transit 105 is distorted.

By capturing and recording this transit, preferably digitally from an imaging device, we can infer the mirror normal at each point where we see the reflection of the star, since we know the star position (by virtue of knowing the time and the location on the earth) and the relative geometry of the camera and heliostat.

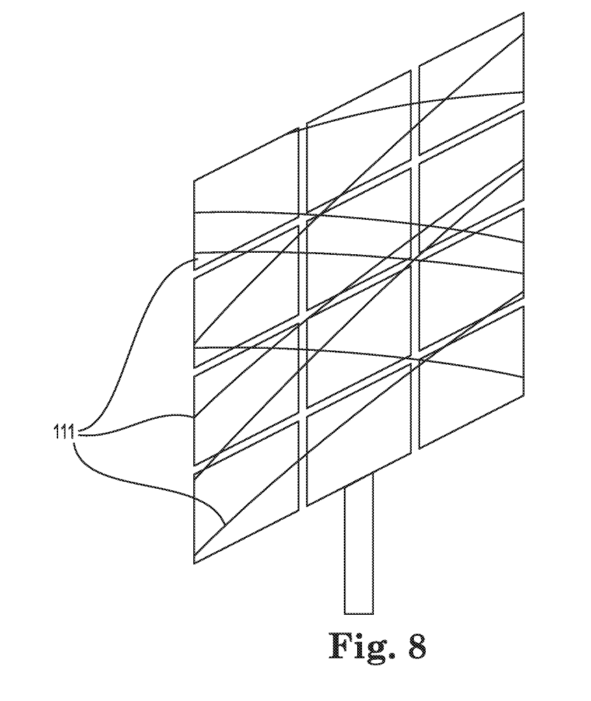

In order to build up a more complete map of a heliostat, in one embodiment, continued observations can be conducted, waiting for one or more additional star transits to occur. As shown in FIG. 8, a rich map of the heliostat mirror surface from a plurality of transits 111 can be eventually built up. This map can then be translated directly into canting and slope measurements.

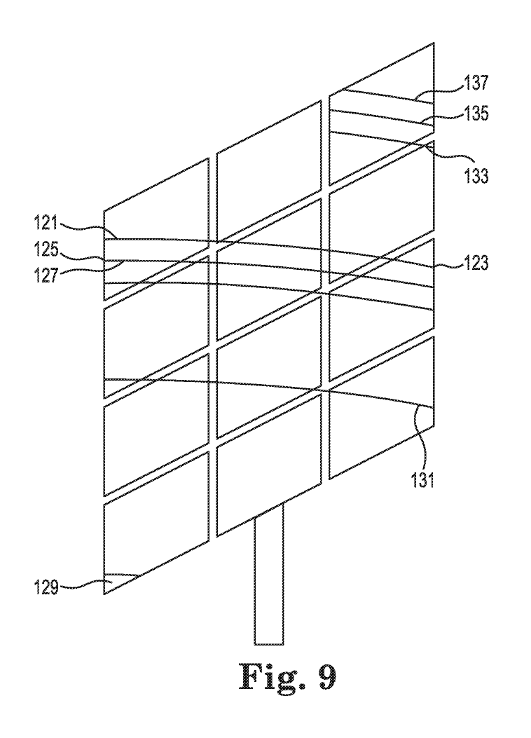

In another embodiment, rather than passively waiting for stars or planets to transit, the heliostat can instead be repointed after a transit is complete, essentially allowing a repeat of the transit at a slightly different position. This is shown in FIG. 9. Here a nominal transit 121 is illustrated. At the end of this transit, the star image leaves the heliostat at point 123. After recording this transit, the heliostat can be moved so that the same star reappears at point 125. Then, by waiting for a period, a star transit 127 can be observed.

By commanding appropriate motions of the heliostat, as many transits as are desired may be obtained. The figure shows additional transits 129, 131, 133, 135, and 137.

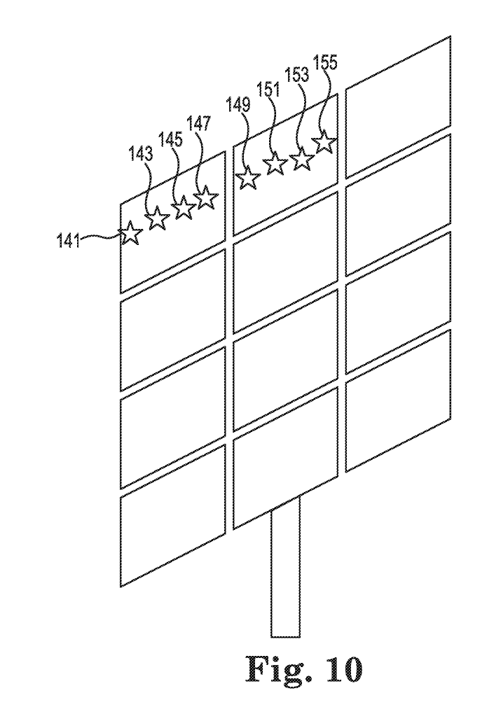

In another embodiment, the use of greater heliostat control can eliminate the need to wait for transits. For example, the heliostat can be controlled to move so as to reflect the star from a specific point on the heliostat. This is shown in FIG. 10. Control includes a step of commanding the heliostat to position the star at point 141. That can be followed up by additional steps to command the star to points 143, 145, and 147.

Moving on to the next facet, further commands to move the reflection of the star to points 149, 151, 153, and 155 can be performed. As is illustrated in FIG. 10, the second facet has a slope error at point 153. As a result, the star image appears shifted. This shift can be converted directly to slope error, and the shift of groups of stars can be converted to canting error.

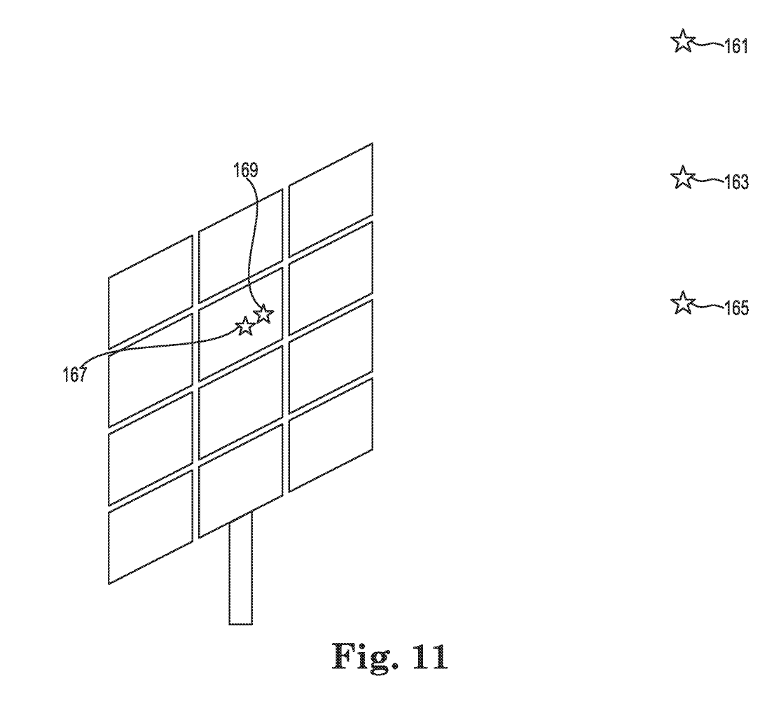

Finally, an embodiment of measuring overall heliostat pointing error is illustrated in FIG. 11. Here, the heliostat is controlled so as to point at stars 161, 163, and 165 in the firmament, with the goal of placing the reflection of each star image exactly in the center of the one of the heliostat's facets, such as at point 167. While the center of a facet is convenient, any predetermined point or set of points may be used.

In this example, the heliostat is able to correctly point at stars 161 and 163, but the image of star 165 appears at an incorrect point 169. This information (both the correct pointing of 161 and 163, and the pointing error for star 165 (the distance between actual image point 169 and desired image point 167) form pointing measurements that can be used to solve the heliostat geometry.

The following methodologies for making measurements in accordance with aspects of the present invention are noted.

The ability to make a slope measurement at a point on a mirror is equivalent to measuring the mirror's normal vector at that point. Making a slope measurement for a point on a mirror therefore comprises the steps of:
1) Observing a star at some point in a heliostat mirror.
2) Computing the mirror normal vector for that point on the mirror by applying the law of reflection. Based on the position of the camera, position of the star, and position of the mirror, the normal vector is the bisector of the mirror-to-camera vector and the mirror-to-star vector.

Making a canting measurement for a mirror facet comprises the steps of:
1) Making one or more slope measurements at one or more points on the mirror facet.
2) Averaging or otherwise combining the slope measurements to produce a net slope. This net slope is the canting of the facet.

Making a pointing measurement for a heliostat comprises the steps of:
1) Positioning the heliostat so that it reflects a star into the camera.
2) Observing the position of the star in the heliostat mirror.
3) Comparing the observed position to the predicted position based on the geometric model of the heliostat, the position of the star, and the position of the camera. The difference is the error in the prediction.
4) Repeat steps 1 through 3, looking at different stars and/or at different times, to collect additional data points. The exact number required depends on the geometric model being used, but can be as few as one or as many as four or even more.
5) Solve for an improved geometric model based on the measured prediction errors. Any technique familiar to one skilled in the art may be used, including least squares, Bayesian estimation, or the like. Some techniques may operate in “batch” mode on all collected points at once, while other techniques may process each point as it arrives, improving the geometric model iteratively.

[92] Also in accordance with the present invention, a means is also preferably provided for digitally assisting with the measurement aspects of the present invention and more preferably with the analyzing and comparing captured digital images with other digital information of the stars. Star information can be obtained electronically in many ways, such as by utilizing the data from the Yale Bright Star Catalog, which can be downloaded from http://tdc-www.harvard.edu/catalogs/bsc5.html. Such a means can comprise one or more general purpose computers. A computer can include software for capturing the image as taken from an imaging device. The computer can include or have access to a data base with star information. The computer can also include digital data comparative programming (as commercially available) for comparing captured images to known data, namely star data for the present invention. From such a comparison, measurements can be determined based upon the above noted methodologies for the type of measurement to be determined. Analytical software can also be utilized for calculating the measurements utilizing star data, heliostat positioning and geometries. It is contemplated as well that a digital image can be compared to a known or image produced based upon known data by any visual examination including that of a human observer.

All patents, patent applications, and publications cited herein are incorporated by reference as if individually incorporated. Unless otherwise indicated, all parts and percentages are by weight and all molecular weights are number average molecular weights. The foregoing detailed description has been given for clarity of understanding only. No unnecessary limitations are to be understood therefrom. The invention is not limited to the exact details shown and described, for variations obvious to one skilled in the art will be included within the invention defined by the claims.

1. A method of measuring one or more heliostat imperfections selected from at least one of a slope error, a canting error, and a pointing error, comprising the steps of:
a) providing a plurality of heliostats and at least one camera that observes at least one heliostat, wherein the heliostats reflect an image of the firmament that can be observed by the at least one camera;
b) reflecting an image of the firmament from at least one of the heliostats:
c) using at least one camera to capture the reflected image of the firmament;
d) using the image comprising the reflected image of the firmament to measure the heliostat imperfection.

2. The method of claim 1, wherein the image of the firmament comprises an image of starlight, and wherein step (c) comprises using at least one camera to capture an imaging comprising reflected starlight, and wherein step (d) comprises using the reflected starlight to measure the heliostat imperfection.

3. The method of claim 1, wherein step (b) comprises reflecting an image of the firmament from a plurality of the heliostats, step (c) comprises capturing reflected images of the firmament from the plurality of the heliostats, and step (d) comprises measuring heliostat imperfections of the plurality of the heliostats.

4-8. (canceled)

9. The method of claim 1, wherein step (d) comprises:
i. comparing the position of a reflected point of the firmament in a captured image with data regarding known positional information of the point; and
ii. determining an error with respect to at least one of a facet slope error, a facet canting error, and a heliostat pointing alignment.

10. (canceled)

11. The method of claim 1, wherein step (c) comprises capturing an image map of the firmament and step (d) comprises using the image map to determine an imperfection of a heliostat facet.

12. The method of claim 1, wherein step (c) comprises recording a firmament illumination pattern as the heliostat is controllably articulated to a predetermined orientation.

13. The method of claim 1, wherein step (c) comprises recording a firmament illumination pattern as the heliostat is controllably articulated along a predetermined path.

14. The method of claim 1, wherein step (c) comprises using a plurality of cameras.

15. The method of claim 1, wherein step (c) comprises using a plurality of cameras at multiple locations.

16. The method of claim 1, wherein step (c) comprises observing the reflections of a star at a plurality of points on a heliostat facet.

17. The method of claim 1, wherein step (c) comprises observing a plurality of points on a heliostat while keeping the heliostat stationary.

18. The method of claim 1, wherein step (c) comprises observing a plurality of star transits on a heliostat;

19. The method of claim 18, further comprising the step of, after observing a star transit, articulating the heliostat to a different position and observing an additional star transit.

20. The method of claim 1, wherein step (b) comprises controlling a heliostat to reflect a point of the firmament from a specific point on the heliostat.

21. The method of claim 1, wherein an imperfection corresponds to an image shift of a reflected image of the firmament.

22. The method of claim 1, wherein an imperfection corresponds to an image distortion of a reflected image of the firmament.

23. (canceled)

24. The method of claim 1, wherein the step (b) comprises reflecting an image of a planet; step (c) comprises capturing the reflected planet image; and step (d) comprises using the image comprising the reflected image of the planet to measure the heliostat imperfection.

25. A heliostat measurement system, comprising:
a) a plurality of heliostats, and
b) at least one camera that observes at least one heliostat, and
wherein the heliostats reflect an image of the firmament that can be observed by the at least one camera; and wherein the system further comprises (i) at least one captured image of the firmament reflected from at least one of the heliostats; and (2) a computer comprising programming that determines a heliostat imperfection from the captured image, wherein the heliostat imperfection is selected from at least one of a slope error, a canting error, and a pointing error.

26. The system of claim 25, wherein the system comprises a plurality of captured images of starlight reflected from a heliostat.

27. The system of claim 25, wherein the system comprises a plurality of captured images of starlight reflected from a plurality of heliostats.

28-31. (canceled)

32. The system of claim 25, wherein the system comprises a plurality of captured images of a planet reflected from a heliostat.
